(19) United States
(12) Patent Application Publication
(10) Pub. No.: US 2019/0063499 A1
(43) Pub. Date: Feb. 28, 2019

(54) SEAL WITH INTEGRATED AIR RELEASE

(71) Applicant: SCHAEFFLER TECHNOLOGIES AG & CO. KG, Herzogenaurach (DE)

(72) Inventors: Igor Cardozo Mendes Ribeiro, Sterling Heights, MI (US); Renato Rodrigues de Paula, Erlangen (DE)

(73) Assignee: SCHAEFFLER TECHNOLOGIES AG & CO. KG, HERZOGENAURACH (DE)

(21) Appl. No.: 15/686,776

(22) Filed: Aug. 25, 2017

(51) Int. Cl. F16C 33/72

(52) U.S. Cl. CPC F16C 33/726

(57) ABSTRACT

Bearing seal assemblies and bearing assemblies including said seal assemblies are disclosed. The bearing seal assembly may include an annular seal including a stiff element, the annular seal configured to be press-fit into a bearing assembly and to form a seal between an interior of the bearing assembly and an exterior of the bearing assembly. The stiff element may have an opening defined therein, and a one-way valve may be configured to allow air to flow through the opening only in a direction from the interior of the bearing assembly to the exterior of the bearing assembly, when the seal is press-fit into the bearing assembly. A flexible member having an opening defined therein may be attached to the stiff element and the openings in the stiff element and the flexible member may at least partially overlap.

### TECHNICAL FIELD

The present disclosure relates generally to seals with integrated air releases, for example, for use in bearing assemblies.

### BACKGROUND

Bearing assemblies generally include a plurality of rolling elements sandwiched between opposing raceways in bearing rings. The rolling elements may take many forms, such as spherical balls, rollers, tapered rollers, barrel-shaped spherical rollers, or others. Bearing assemblies are used in a wide range of applications, including in vehicles. In order to prevent or reduce ingress of contaminants or egress of lubricants, the bearing assembly may include one or more seals.

### SUMMARY

In at least one embodiment, a bearing seal assembly is provided. The assembly may include an annular seal including a stiff element, the annular seal configured to be press-fit into a bearing assembly and to form a seal between an interior of the bearing assembly and an exterior of the bearing assembly; the stiff element having an opening defined therein; and a one-way valve configured to allow air to flow through the opening only in a direction from the interior of the bearing assembly to the exterior of the bearing assembly, when the seal is press-fit into the bearing assembly.

In one embodiment, a flexible member having an opening defined therein may be attached to the stiff element and the openings in the stiff element and the flexible member may at least partially overlap. The openings in the stiff element and the flexible member may be concentric and configured to form a fluid flow path from the interior of the bearing assembly to the exterior of the bearing assembly. The annular seal may be a first annular seal and the stiff element may be a first stiff element and the assembly may further comprise a second annular seal including a second stiff element, the second annular seal configured to be press-fit into the bearing assembly. The first and second annular seals may be configured to be press-fit into opposing rings of the bearing assembly. A gap may be formed between the first and second annular seals, the gap being located on an exterior-side of the seal between the interior of the bearing assembly and the exterior of the bearing assembly. In one embodiment, the gap is formed between the flexible member and the second stiff element. The opening in the stiff element may be disposed in a region of the stiff element extending in a generally radial direction. In one embodiment, a plurality of openings are defined in the stiff element and a plurality of corresponding one-way valves are configured to allow air to flow through the openings only in a direction from the interior of the bearing assembly to the exterior of the bearing assembly, when the seal is press-fit into the bearing assembly.

In at least one embodiment, a bearing assembly is provided. The assembly may include inner and outer bearing rings; a first annular seal including a stiff element, the annular seal press-fit into one of the inner or outer bearing rings and forming a seal between an interior of the bearing assembly and an exterior of the bearing assembly; the stiff element having an opening defined therein; and a one-way valve configured to allow air to flow through the opening only in a direction from the interior of the bearing assembly to the exterior of the bearing assembly.

In one embodiment, a flexible member having an opening defined therein is attached to the stiff element and the openings in the stiff element and the flexible member at least partially overlap. The openings in the stiff element and the flexible member may be concentric and may be configured to form a fluid flow path from the interior of the bearing assembly to the exterior of the bearing assembly. The assembly may include a second annular seal including a second stiff element, the second annular seal configured to be press-fit into an opposite bearing ring from the first annular seal. A gap may be formed between the first and second annular seals, the gap being located on an exterior-side of the seal between the interior of the bearing assembly and the exterior of the bearing assembly. In one embodiment, a plurality of openings are defined in the stiff element and a plurality of corresponding one-way valves are configured to allow air to flow through the openings only in a direction from the interior of the bearing assembly to the exterior of the bearing assembly, when the seal is press-fit into the bearing assembly.

In at least one embodiment, a method is provided. The method may include press-fitting a first seal assembly into a first axial end of a bearing assembly; press-fitting a second seal assembly into a second axial end of a bearing assembly, opposite the first axial end; at least one of the first or second seal assemblies includes an annular seal having an opening defined therein and a one-way valve configured to allow air to flow through the opening only in a direction from an interior of the bearing assembly to an exterior of the bearing assembly; and press-fitting the second seal assembly causes air to be pressurized within the bearing assembly and the pressurized air is released by the one-way valve during the press-fitting of the second seal assembly.

In one embodiment, only one of the first or second seal assemblies includes an annular seal including a one-way valve. In another embodiment, the first seal assembly may include the annular seal including the one-way valve and the pressurized air may be released by the one-way valve through the first seal assembly during the press-fitting of the second seal assembly. In another embodiment, the second seal assembly may include the annular seal including the one-way valve and the pressurized air may released by the one-way valve through the second seal assembly during the press-fitting of the second seal assembly. In another embodiment, each of the first and second seal assemblies includes an annular seal including a one-way valve and the pressurized air is released by the one-way valve in one or both of the first and second seal assemblies during the press-fitting of the second seal assembly.

### BRIEF DESCRIPTION OF THE DRAWINGS

FIG. 1 is a cross-section of a bearing assembly prior to seals being inserted;

FIG. 2 is a cross-section of the bearing assembly of FIG. 1 with one seal inserted.

FIG. 3 is a cross-section of the bearing assembly of FIG. 1 with both seals inserted.

FIG. 4 is an enlarged view of FIG. 3 showing internal air pressure acting on one of the seals;

FIG. 5 is a front plan view of a seal including a one-way valve, according to an embodiment;

FIG. 6 is an enlarged view of FIG. 5; and

FIG. 7 is a cross-section of a bearing assembly having a seal including a one-way valve, according to an embodiment, and an airflow path from inside the bearing assembly to outside the bearing assembly via the valve.

### DETAILED DESCRIPTION

At the outset, it should be appreciated that like drawing numbers appearing in different drawing views identify identical, or functionally similar, structural elements. Furthermore, it is understood that this disclosure is not limited only to the particular embodiments, methodology, materials and modifications described herein, and as such may, of course, vary. As those of ordinary skill in the art will understand, various features illustrated and described with reference to any one of the figures can be combined with features illustrated in one or more other figures to produce embodiments that are not explicitly illustrated or described.

The terminology used herein is for the purpose of describing particular aspects only, and is not intended to limit the scope of the present disclosure, which is limited only by the appended claims. It is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

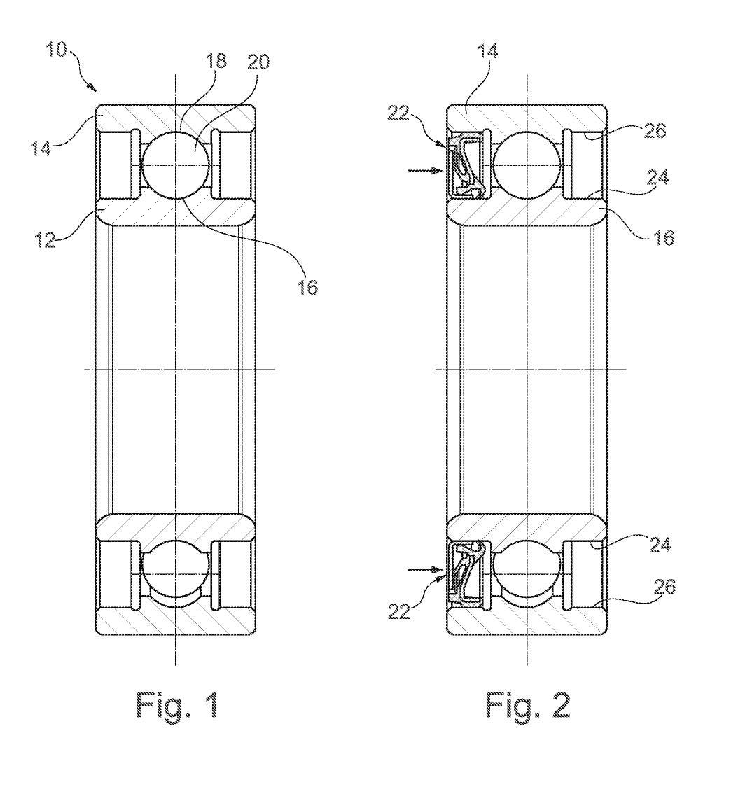

With reference to FIG. 1, a bearing assembly 10 is shown. The bearing assembly 10 may include an inner bearing ring 12 and an outer bearing ring 14. The inner bearing ring 12 may define an inner race 16 and the outer bearing ring 14 may define an outer race 18. One or more (e.g., a plurality) of rolling elements 20 may be disposed and/or supported between the inner race 16 and the outer race 18 when the bearing assembly 10 is assembled. In the embodiment shown, the rolling elements 20 are spherical (e.g., ball bearings). However, any suitable type of rolling element may be used, such as roller bearings or others. Non-limiting examples of roller bearings may include cylindrical, cone-shaped/tapered, barrel shaped, or others.

With reference to FIG. 2, to prevent or reduce the ingress of contaminants (e.g., dirt, water, etc.) into the bearing assembly or the egress of lubricants (e.g., oil, grease, etc.) from within the bearing assembly, a seal 22 may be inserted between the inner bearing ring 12 and the outer bearing ring 14. The seal 22 may be annular in shape and may contact and/or form a seal with an outer radial surface 24 of the inner bearing ring 12 and/or an inner radial surface 26 of the outer bearing ring 14. The particular design or shape of the seal 22 may vary depending on the bearing assembly. In general, the seal 22 may include one or more metal portions, which may provide stiffness or rigidity, and one or more flexible portions, which may conform to the surface with which it is in contact to form a seal. The flexible portions may be formed of a polymer material, such as an elastomer (e.g., rubber).

FIG. 2 illustrates the insertion of a seal assembly 22 into one side (left side, as shown) of the bearing assembly 10. The seal assembly 22 may be pressed into the opening between the inner and outer bearing rings 12 and 14. An interference fit may therefore be formed between one or more portions of the seal assembly 22 and the outer radial surface 24 of the inner bearing ring 12 and/or an inner radial surface 26 of the outer bearing ring 14.

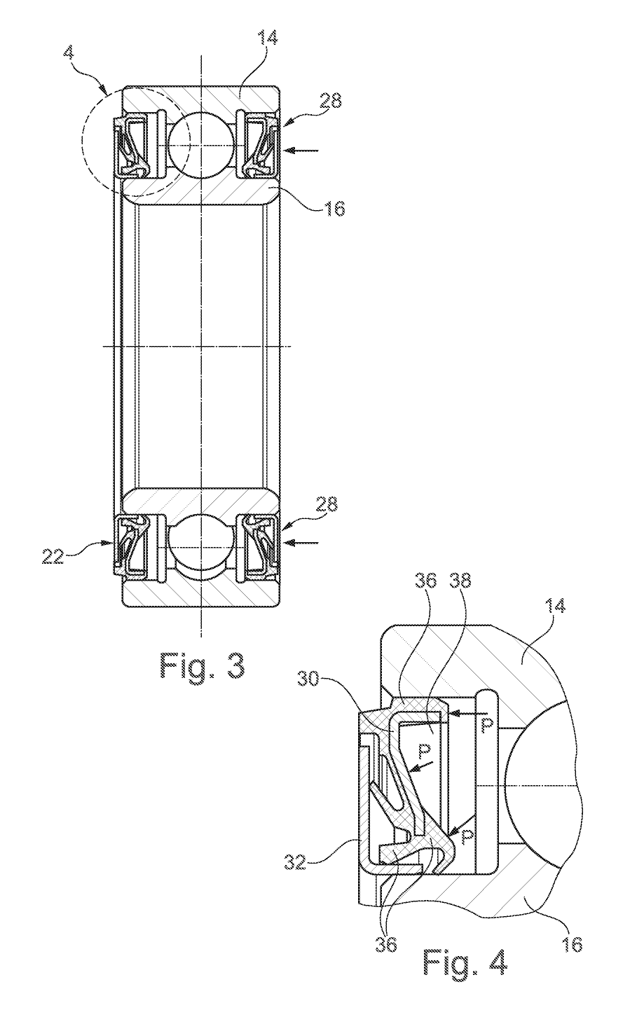

With reference to FIG. 3, a second seal assembly 28 may be inserted into the other side (right side, as shown) of the bearing assembly. The second seal assembly 28 may be substantially the same as the seal assembly 22 on the left side, but may be mirrored along the vertical axis (as shown). It has been discovered that during the insertion of the second seal assembly 28 (e.g., by pressing), air within the bearing assembly 10 may be compressed and pressurized.

With reference to FIG. 4, an enlarged view of the first seal assembly 22 is shown during/after the insertion of the second seal assembly 28. In the embodiment show, the first seal assembly includes a first stiff element 30 (e.g., formed of metal, such as steel) that is coupled or attached to the inner radial surface 26 of the outer bearing ring 14. For example, the first stiff element 30 may be interference or press-fit into the outer bearing ring 14. A second stiff element 32 (e.g., formed of metal, such as steel) may be coupled or attached to the outer radial surface 24 of the inner bearing ring 12. For example, the second stiff element 32 may be interference or press-fit into the inner bearing ring 12. The first seal 22 may include one or more flexible elements 36, which may be attached to the first and/or second stiff element 30, 32, for example, by over-molding. In the embodiment shown, a flexible element 36 is attached to the first stiff element 30 and portions of the flexible element 36 sealingly engage the second stiff element 32 and the outer radial surface 24 of the inner bearing ring 12.

While the flexible element 36 is shown as attached to the first stiff element 30, it may be alternatively attached to the second stiff element 32 or there may be multiple flexible elements 36 attached to one or both of the stiff elements. In addition, the shape of the flexible element 36 shown is merely an example, and other designs or shapes may be used. As a result of the sealing engagement by the flexible portion 36, a cavity or chamber 38 may be formed within the seal assembly 22. The cavity 38 may be annular or ring-shaped and may be sealed off from the exterior of the bearing assembly, at least in the direction axially opposite the rolling elements 20.

As described above, when a second seal assembly 28 is inserted into the bearing assembly 10 on the axially opposite side from the first seal assembly 22, air may be pushed axially inward towards the first seal assembly 22. Due to the sealing engagement of the first seal assembly 22 with the inner and outer bearing rings, this air may be not able to escape, or may at least be significantly and/or substantially slowed in its release. Accordingly, air in the cavity 38 may become compressed and may apply pressure on the surfaces of the seal assembly 22 in the cavity 38 (e.g., as indicated by the arrows). In some instances, the pressure applied to the first seal assembly 22 may be sufficient to cause the first seal assembly 22 to move or shift, which may cause a gap in the seal formed between the first seal assembly 22 and the bearing rings. In some situations, the first seal assembly 22 may even be completely dislodged from the bearing assembly 10, and may have to be reinserted.

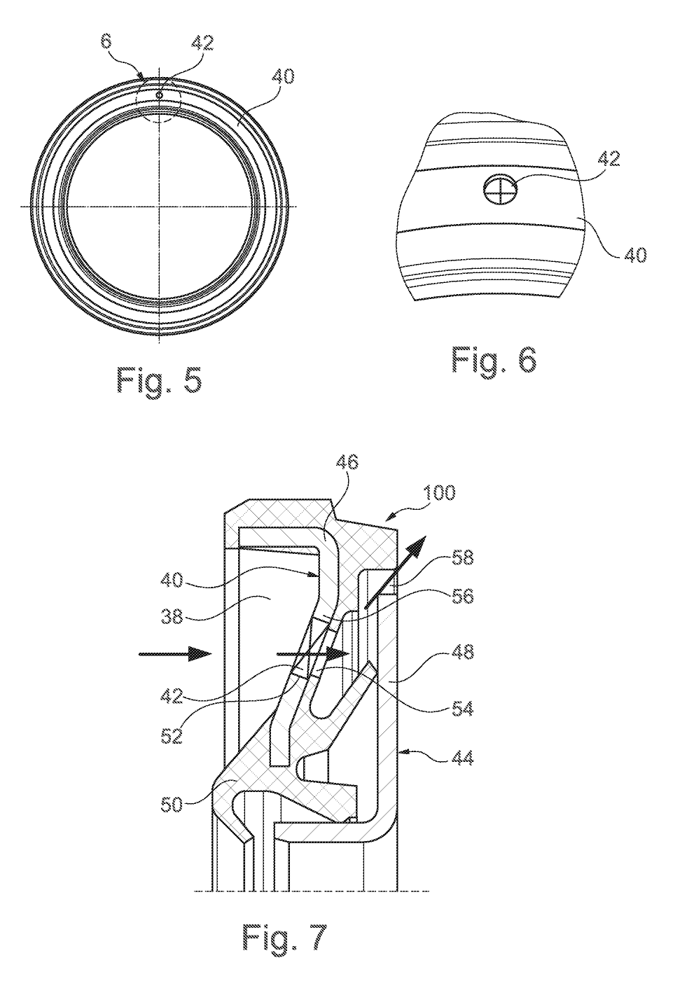

With reference to FIGS. 5 and 6, a seal 40 is shown. In at least one embodiment, the seal 40 may allow air from inside the cavity 38 to be released, thereby relieving internal air pressure and reducing/mitigating or eliminating the problems described above with respect to the seal 22 shifting/moving/dislodging when a seal is inserted on the opposite side. The seal 40 may include one or more valves 42, which may be configured to allow air to escape from inside the seal (e.g., from an axially inward side) to the atmosphere. In the embodiment shown, there is a single valve 42, however, there may be a plurality of valves 42. If there are multiple valves 42, they may be circumferentially spaced about the seal 40, for example, evenly/uniformly spaced. In one embodiment, the valve(s) 42 may be one-way valves, such that air can only flow from inside the bearing assembly to the surrounding atmosphere. Accordingly, air and/or contaminants from outside the bearing assembly may not flow into the bearing assembly via the valve(s) 42.

With reference to FIG. 7, a seal assembly 100 is shown in cross-section. The assembly may include the seal 40, including a valve 42. In at least one embodiment, the seal assembly 100 may include two or more pieces. For example, one piece may be configured to contact and/or be secured to/within the inner bearing ring 12 and another piece may be configured to contact and/or be secured to/within the outer bearing ring 14. In the embodiment shown, the seal 40 may be configured to contact and/or be secured to/within the outer bearing ring 14 and a second seal 44 configured to contact and/or be secured to/within the inner bearing ring 12. However, one of ordinary skill in the art will understand, based on the present disclosure, that the configuration may be reversed.

The seal 40 may include a first stiff element 46 (e.g., formed of metal, such as steel) that is similar to the stiff element 30 described above, except for the addition of the valve 42. For example, the first stiff element 46 may be interference or press-fit into the outer bearing ring 14. The second seal 44 may include a second stiff element 48 (e.g., formed of metal, such as steel) that is similar to the stiff element 32 described above. For example, the second stiff element 48 may be interference or press-fit into the inner bearing ring 12. The seal 40 may include one or more flexible elements 50, which may be attached to the first stiff element 46, for example, by over-molding. In the embodiment shown, the flexible element 50 is attached to the first stiff element 30 and portions of the flexible element 50 sealingly engage the second stiff element 48. While a flexible element 50 is present in the illustrated embodiment, in other embodiments it may not be present.

In the embodiment shown, the second seal 44 does not include a flexible element, and is comprised of just the second stiff element 48. However, in other embodiments, the second stiff element may have one or more flexible elements attached thereto (e.g., by over-molding). Similar to above, one of ordinary skill in the art will understand, based on the present disclosure, that the configuration of the elements in seal assembly 100 may be rearranged and/or modified.

In at least one embodiment, the valve(s) 42 may be disposed at least within an opening or aperture 52 defined in the first stiff element 46 of the seal 40. If the portion or region of the first stiff element 46 that includes the valve 42 is covered by a flexible element 50, then the flexible element 50 may also include an opening or aperture 54 defined therein. The aperture 54 may fully or at least partially overlap with the aperture 52, such that a fluid flow path is provided through both apertures. In one embodiment, the apertures 52 and 54 may be concentric. In another embodiment, the apertures 52 and 54 may have a same or substantially the same diameter (e.g., ±10%). The apertures 52 and/or 54 may be sized and configured to receive the valve 42. The valve 42 may be disposed in one or both of the apertures 52/54. If the valve 42 is only disposed in one of the apertures 52/54, the other aperture may act as a conduit to allow air to flow therethrough. For example, if the valve 42 is disposed within only the aperture 52, the aperture 54 may serve to allow airflow through the flexible member 50, which would otherwise prevent the air from escaping. The opposite may be true if the valve 42 is disposed only in aperture 54.

The valve 42, and the aperture in which it is disposed, may be located in any portion or region of the seal 40 that is not in direct contact with another element in the seal assembly 100 or the bearing assembly 10. Stated another way, the valve and aperture may be located in any portion or region of the seal 40 that would allow air that flows therethrough to escape to the atmosphere. In one embodiment, the valve 42 may be disposed in a portion 56 of the first stiff element 46 that extends in a generally radial direction. The term “generally radial” may refer to a direction that is primarily or mostly in the radial direction, but not completely parallel thereto. For example, the first stiff element 46 shown in FIG. 7 may be considered to extend in the generally radial direction. Stated another way, the valve 42 may be disposed within a portion 56 of the first stiff element 46 that extends between the inner and outer bearing rings (although it may not contact one or either ring). Accordingly, the valve 42 may be disposed in a portion of the first stiff element 46 that is not parallel to the axial direction of the bearing assembly.

In operation, one seal assembly 100 may be inserted into one axial end of the bearing assembly 10 (e.g., by press or interference fit). A second seal assembly 100 may then be inserted into the other, opposite axial end of the bearing assembly 10 (e.g., by press or interference fit). During insertion of the second sealing assembly, air may be compressed within the bearing assembly, for example, in the cavity 38 (described above). However, the compressed air may be allowed to escape the cavity 38 via the valve(s) 42 in the seal 40. The air may flow through the valve(s) 42 (e.g., one-way valves) and may be vented to the surrounding atmosphere. In the embodiment shown, the air may escape through a gap 58 (e.g., an annular gap) between the seal 40 and the second seal 44. For example, the gap 58 may be between the second stiff element 48 and a flexible member 50 attached to the first stiff element 46.

By allowing for air to escape from inside the bearing assembly, shifting, moving, or complete dislodging of the seal assemblies (e.g., the first inserted assembly) may be mitigated or avoided completely. In one embodiment, both seal assemblies may include the disclosed one or more valves. Therefore, the order of insertion may not matter, since either seal assembly is able to vent the compressed air during the press-in operation. However, in other embodiments, only one seal assembly may include the disclosed valve(s). In these instances, the seal assembly including the valve(s) may be inserted first and a seal assembly without a valve may be inserted second. The compressed air may therefore still be allowed to escape from the first-installed seal assembly without it becoming shifted or dislodged. In another embodiment, the second-installed seal assembly may be the only assembly with a valve or valves. In this embodiment, the back-pressure from the non-vented first seal assembly may be alleviated by air escaping from the valve(s) in the second seal assembly as the latter is being installed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A bearing seal assembly, comprising:
an annular seal including a stiff element, the annular seal configured to be press-fit into a bearing assembly and to form a seal between an interior of the bearing assembly and an exterior of the bearing assembly;
the stiff element having an opening defined therein; and
a one-way valve configured to allow air to flow through the opening only in a direction from the interior of the bearing assembly to the exterior of the bearing assembly, when the seal is press-fit into the bearing assembly.

2. The assembly of claim 1, wherein a flexible member having an opening defined therein is attached to the stiff element and the openings in the stiff element and the flexible member at least partially overlap.

3. The assembly of claim 2, wherein the openings in the stiff element and the flexible member are concentric and are configured to form a fluid flow path from the interior of the bearing assembly to the exterior of the bearing assembly.

4. The assembly of claim 2, wherein the annular seal is a first annular seal and the stiff element is a first stiff element and the assembly further comprises a second annular seal including a second stiff element, the second annular seal configured to be press-fit into the bearing assembly.

5. The assembly of claim 4, wherein the first and second annular seals are configured to be press-fit into opposing rings of the bearing assembly.

6. The assembly of claim 5, wherein a gap is formed between the first and second annular seals, the gap being located on an exterior-side of the seal between the interior of the bearing assembly and the exterior of the bearing assembly.

7. The assembly of claim 6, wherein the gap is formed between the flexible member and the second stiff element.

8. The assembly of claim 1, wherein the opening in the stiff element is disposed in a region of the stiff element extending in a generally radial direction.

9. The assembly of claim 1, wherein a plurality of openings are defined in the stiff element and a plurality of corresponding one-way valves are configured to allow air to flow through the openings only in a direction from the interior of the bearing assembly to the exterior of the bearing assembly, when the seal is press-fit into the bearing assembly.

10. A bearing assembly, comprising:
inner and outer bearing rings;
a first annular seal including a stiff element, the annular seal press-fit into one of the inner or outer bearing rings and forming a seal between an interior of the bearing assembly and an exterior of the bearing assembly;
the stiff element having an opening defined therein; and
a one-way valve configured to allow air to flow through the opening only in a direction from the interior of the bearing assembly to the exterior of the bearing assembly.

11. The assembly of claim 10, wherein a flexible member having an opening defined therein is attached to the stiff element and the openings in the stiff element and the flexible member at least partially overlap.

12. The assembly of claim 11, wherein the openings in the stiff element and the flexible member are concentric and are configured to form a fluid flow path from the interior of the bearing assembly to the exterior of the bearing assembly.

13. The assembly of claim 11, further comprising a second annular seal including a second stiff element, the second annular seal configured to be press-fit into an opposite bearing ring from the first annular seal.

14. The assembly of claim 13, wherein a gap is formed between the first and second annular seals, the gap being located on an exterior-side of the seal between the interior of the bearing assembly and the exterior of the bearing assembly.

15. The assembly of claim 10, wherein a plurality of openings are defined in the stiff element and a plurality of corresponding one-way valves are configured to allow air to flow through the openings only in a direction from the interior of the bearing assembly to the exterior of the bearing assembly, when the seal is press-fit into the bearing assembly.

16. A method, comprising:
press-fitting a first seal assembly into a first axial end of a bearing assembly;
press-fitting a second seal assembly into a second axial end of a bearing assembly, opposite the first axial end;
at least one of the first or second seal assemblies includes an annular seal having an opening defined therein and a one-way valve configured to allow air to flow through the opening only in a direction from an interior of the bearing assembly to an exterior of the bearing assembly; and
press-fitting the second seal assembly causes air to be pressurized within the bearing assembly and the pressurized air is released by the one-way valve during the press-fitting of the second seal assembly.

17. The method of claim 16, wherein only one of the first or second seal assemblies includes an annular seal including a one-way valve.

18. The method of claim 17, wherein the first seal assembly includes the annular seal including the one-way valve and the pressurized air is released by the one-way valve through the first seal assembly during the press-fitting of the second seal assembly.

19. The method of claim 17, wherein the second seal assembly includes the annular seal including the one-way valve and the pressurized air is released by the one-way valve through the second seal assembly during the press-fitting of the second seal assembly.

20. The method of claim 16, wherein each of the first and second seal assemblies includes an annular seal including a one-way valve and the pressurized air is released by the one-way valve in one or both of the first and second seal assemblies during the press-fitting of the second seal assembly.
